(19) United States
(12) Patent Application Publication
(10) Pub. No.: US 2023/0383727 A1
(43) Pub. Date: Nov. 30, 2023

(54) SOLAR POWERED WIND TURBINE

(71) Applicant: Mohd Riyad Darraj, Centreville, VA (US)

(72) Inventor: Mohd Riyad Darraj, Centreville, VA (US)

(21) Appl. No.: 17/804,235

(22) Filed: May 26, 2022

(51) Int. Cl. F03D 9/00; F03D 9/11; F03D 9/25; H02K 7/18; H02S 10/12

(52) U.S. Cl. CPC F03D 9/007; F03D 9/11; F03D 9/25; H02K 7/183; H02S 10/12; F05B 2220/708; F05B 2220/706

(57) ABSTRACT

A solar powered wind turbine system includes an air intake, a chimney including a top opening and a bottom opening, and a tapered outlet section, wherein the cross sectional area of the tapered section has an area that is about 1-10% of the peripheral opening area; a solar power concentrator to heat a thermal transfer medium; a thermal storage unit for storing the thermal transfer medium; a chimney comprising a top and a bottom that encloses the tower, the tower comprising a wind turbine comprising blades disposed at the top of the tower, a radiator disposed at the base opening of the tower, wherein the thermal transfer medium is transported to the radiator from the thermal storage unit and the radiator heats air from the air intake opening; a wind turbine; an electrical generator connected to the wind turbine; and a power storage device connected to the electrical generator.

### BACKGROUND

### Technical Field of the Invention

The field of this invention relates to wind turbines for electrical power generation. More specifically, wind turbines that utilize alternative sources of energy including solar power.

### Description of the Related Art

The burning of fossil fuels has been generally considered a cause of global warming via the greenhouse effect in Earth's atmosphere. This is considered responsible for many environmental effects along with related natural weather disasters, floods, forest fires, etc. in addition, current renewable energy systems are responsible for killing or disturbing many types of wildlife. Wind turbines, for example, are responsible for killing birds in large numbers by disturbing migratory paths as well as through sunray reflectors at solar power plants.

In addition, challenges for new renewable-energy power plants required providing safer surrounding to wildlife include avoiding exposing wildlife to large wind turbine propeller blades, minimizing the footprint used by a power plant to avoid disturbing wildlife habitat, and avoiding the use of sunray reflectors which can harm and kill wildlife.

### SUMMARY DISCLOSURE OF THE INVENTION

In embodiments, a solar powered wind turbine system includes an air intake, a chimney including a top opening and a bottom opening, and a tapered outlet section, wherein the cross sectional area of the tapered section is 1-10% of the peripheral opening area; a solar power concentrator to heat a thermal transfer medium; a thermal storage unit for storing the thermal transfer medium; a chimney comprising a top and a bottom that encloses the tower, the tower comprising a wind turbine comprising blades disposed at the top of the tower, a radiator disposed at the base opening of the tower, wherein the thermal transfer medium is transported to the radiator from the thermal storage unit and the radiator heats air from the air intake opening; a wind turbine comprising wind turbine blades, wherein the wind turbine blades comprise an airfoil; an electrical generator connected to the wind turbine; and a power storage device connected to the electrical generator.

In embodiments, a solar powered wind turbine system may include a circular wind collector basin with an air intake opening at the periphery, a central tower enclosed by a chimney with a bottom opening and a top tapered air outtake opening, wherein the tapered sectional area of the chimney is approximately 1-10% of the circumference area at periphery, a solar power concentrator to heat a thermal transfer medium, a thermal storage unit for storing the thermal transfer medium, a radiator disposed at the base of the tower, wherein the thermal transfer medium is transported to the radiator from the thermal storage unit and the radiator heats the incoming air flow from the air intake opening at the wind collector basin periphery, a wind turbine comprising wind turbine blades disposed at the top of the tower, wherein the wind turbine blades comprise a set of airfoils shape distributed evenly over the tip end of a rounded metal structure/frame shaping a merry-go-round spinner a like, a set of electrical generators connected to the wind turbine main shaft through mechanical gears; and a power storage device connected to the electrical generators.

Other features and aspects will be apparent from the following detailed description, the drawings, and the claims

### BRIEF DESCRIPTION OF THE DRAWINGS

FIG. 1 shows an embodiment of a solar powered wind turbine system of the disclosure.

FIG. 2 shows an embodiment of the tower and airflow of a solar powered wind turbine system of the disclosure.

FIG. 3 shows an embodiment of a sectional view of the air collection basin, the tower, the chimney, and the airflow path of a solar powered wind turbine system of the disclosure.

FIG. 4 shows an embodiment of solar concentrator units of a solar powered wind turbine system of the disclosure.

FIG. 5 shows the main component of the tower including the wind turbine generator of a solar powered wind turbine system of the disclosure.

FIG. 6 shows an embodiment of an air collector basin component units of a solar powered wind turbine system of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

In embodiments, the disclosed solar powered wind turbine system overcomes many of the challenges of modern power plants by providing a clean source of energy using environmentally friendly materials and design, has a long lifespan, required minimum manpower by utilizing automation technology and is low in maintenance, which may represent a new generation of power plant and an example of a sustainable and high performing system.

In embodiments, the disclosed solar powered wind turbine takes advantage of a fundamental property of fluids/gases, including air, i.e., that hot air rises and cold air sinks. That is, air moves from high-pressure regions to low-pressure regions creating convective air currents.

The disclosed invention utilizes thermal convection in conjunction with a chimney to produce a stack effect as well as the use of solar energy to feed a stove/heater with the required energy to create maximum air buoyancy and faster air movement. The invention of the disclosure provides a high convective rate of volume of air, accelerating air updraft speed, wherein the rising air is used to operate a vertical blade turbine structure to produce mechanical energy that can be converted into electrical power using electrical generators.

### Modes for Carrying Out the Invention

The disclosed solar powered wind turbine is a renewable energy power plant that includes two systems, a solar powered system and a wind powered system which are combined to provide renewable energy, that integrates renewable energy technology from solar power and wind power.

In embodiments, the solar powered wind turbine includes an air collection region surrounding a central chimney, that encloses a central tower to produce air convection updrafts using a chimney effect. Where the air collection area diameter may range between 25-250 m or optimized to about 150 m (492 feet) diameter, while maintaining a special building design characteristic at the periphery, by having a quarter round curvature shape at the air basin's roof that can collect and generate a greater volume of air flow towards the tower base up the chimney. The chimney may be 75-150 m or optimized to about 100 m (320 feet) in length from the top (trailing) edge of the blades, while maintaining a special building design characteristic at the air outtake opening of the chimney, by having a tapered shape outlet opening that can increase the air outtake velocity resulting in higher plume and better dispersion, also to avoid downwash effect. While higher chimney could provide better stack effect properties by increasing the pressure difference but could have a negative effect on the system performance due to heat dissipation at higher chimney level and colder zone buildups, resulting in slower air velocity.

In embodiments, while the diameter dimension of the tower may be 2.5-25 m or optimized to the best economical diameter of 15 meters (49.21 foot), the dimension of the air collection area is maintained to be as small as possible in order to produce the required air flow energy and also provide a smaller footprint, saving land space, which minimizes impact on the environment and wildlife and provides flexibility in the geographic placement of power plants. A semi-encapsulated design provides safer surroundings and can be deployed in rural or urban settings. The design also provides significant benefits by reducing the cost of connecting the system to power grid lines by reducing the energy dissipation which occurs over long electrical transmission distances.

The invention of the disclosure uses the updraft power of rising convection hot air currents in an optimized manner, to maximize generator power output while maintaining a highly controlled working environment. Multiple solar concentrator units equipped with sun tracker system may direct sunrays to a focal point, heating up a medium, for example, an oil or treated oil medium. In embodiments, the solar concentrator units may be distributed at the top of an air collector roof area. The medium can in turn be carried through well insulated pipes to underground thermal storage tanks containing, for example, a solar salt medium. The pipes may be, for example, stainless steel pipes.

The heat energy can then be circulated from thermal storage tanks through insulated pipes (stainless steel) to a stove piping system forming a radiator style shape at the base of the tower. This design can release a large amount of heat energy (up to 500° C.) and create a high-pressure difference between atmospheric pressure and the inner core of the air collection area consequently producing a high air intake zone and a high-speed (up to 300 km/h) draft airflow up the chimney.

Airfoil/blades when impacted by the rising air flow generate lift. The generated lifting force is sufficient to rotate wind turbine configuration located at the top of the tower that may be at 20-80 m height from ground level or optimized to 40 m height. The mechanical power produced by the turbine blades rotational motion is transferred to a main shaft enabling, for example, a gear configuration to drive electric generators. For example, there may be 1-10 generators, or about 5 working and 1 standby electric generator each of up to 100 MW capacity, producing an average of 50-500 MW or more (based on design) of electricity enough to supply about 25,000-250,000 homes or more. The electric power can then be divided into two power lines based on demand at any given point of time. One power line can feed a grid line, while the other powerline can carry excess power to a large power bank arrangement providing up to 1 to 2 weeks of uninterrupted supply capacity which can be located at the bottom level of the air collection area. The stored power can be used during peak hours or during system shutdowns which can be caused by any number of reasons including emergencies or maintenance work.

In embodiments, the disclosed system includes the following elements: air collector or intake basin, tower, chimney, solar power concentrators, thermal storage units, heater or stove arrangements, centrifugal vertical wind turbine, electrical generators, and power bank units. In embodiments, a circular shaped air collection area open at the periphery surrounds and is connected to a central chimney. The air collection area may include three layers: a top-level (roof area), middle level (basin), and a bottom level (basement or underground area).

The air collector or intake basin, in embodiments, may be approximately 25-250 m or about 150 m diameter reinforced concrete building with an airway intake opening at the periphery secured with a bird fence, smooth inclination flooring that may ramp up at 1-10 degree or approximately 5-degree slope from ground level to a certain height at the center towards the tower base. In addition, the roof of the air collector area has a 1-5 m radius or about 3 m radius quarter round curve shape canopy at the periphery, this design can collect greater air volume, in embodiments, the roof slab is supported by the mean of columns and beams, and extended with maintained smooth inclination in roof height, for example, from 5 m near the periphery to 3 m near the tower base, at 1-5 degrees or about a 3-degree slope from the periphery to a certain height at the endpoint toward the center, in embodiments, the height between the roof and the floor of the air collector area gets narrower when moving towered the center, this design can provide seamless and smoother airflow, also foster Bernoulli effect for higher velocity airflow at constriction/narrow passage.

The horizontal air deflectors are located within the air collector area, and may be, distributed radially or spirally, the intake air flow from the periphery can be guided toward the tower base through the means of directional partitions, for example, a straight or spiral walls which represents a horizontal air deflector, the walls, and the pillars within the air intake basin, can have a thin cross section, for example, narrow elliptical shape with knife tip alike at both ends for smoother air flow. The closer air deflectors to the tower base can be rotated, for example, clockwise at different angles 5-35 degrees to produce a counterclockwise twister airflow at the tower base, this formation provides better air mixture of the incoming airflow for better performance of the system, and could be composed of 10-50 units, or may be 40 units of deflectors, and can be of different sizes and could be of crescent/spiral or straight shape. The orientation, insulation, and thermal properties of each component may be important for harnessing, retaining, and utilizing airflow energy and to provide maximum efficiency.

The tower is the core of the system and located at the center of the air collection area, the tower base may have a wine glass base shape, this design can provide smoother air flow. Many of the system components are attached or included within the tower, for example, the radiator at the base, air shutters, vertical air deflectors, the staircase, the control booth, the generators room, and the wind turbine at the top of the tower, etc.

The chimney may be 25-250 m or about 100 m in height starting from the top end of the blades/airfoils, enclosing the tower, and located at the center of the air collection area, and may have a diameter, design, and structure to provide important aerodynamic properties. A tapered design optimizes height to provide smooth airflow and maintain a constant flux of hot air from the chimney base rising to the top of the chimney. Airflow through the chimney may be controlled through mechanical shutters and a set of air vents/apertures to ensure constant and fully controlled airflow. This provides better output and safer operation. This controlled rising airflow is also guided through the mean of vertical air deflectors set of 10-40 deflector units or about 20 deflector units, this formation maintains direct air blow toward the leading edges of the blades/airfoils.

The solar collector system may include multiple solar concentrator units equipped with sun tracking system and distributed, in embodiments, evenly at the roof of the air collection area. This would allow collection of as much sunlight as possible to produce maximum heat. The solar concentrator focal points heat up, for example, an oil medium which can carry heat through insulated pipes or tubes to thermal storage tanks.

The thermal energy storage system may provide thermal storage capacity for up to one month. In one example, cylindrical or hexagonal prism tanks filled with solar salt can be located underneath the air collection area. In one example, the tanks may be spread in a honeycomb cell arrangement which minimizes piping connection requirements and reduces cost. The main component of these elements may be a treated solar salt kept in insulated thermal storage tanks that provides a heat reservoir.

A solar stove arrangement is located inside the air collection area at the base of the tower and may include pipes, including steel pipes, configured in a stove range shape that can act as a radiator. This arrangement receives heat energy from the thermal storage units, for example, through a circulated thermal medium using a network of pipes and releases the heat into the tower base.

Turbine blades are located at the top of the tower at an approximate height of 40 meters from ground. The size, design, angle of attack, as well as other aerodynamic aspects of the turbine blades are important. The blade component of a wind turbine rotor typically has a vertical rotor shaft, which includes a hub connected to the blades by a steel/aluminum frame and extend radially. The blades arrangement is composed of about 30-50 blades or about 40 blades which can be optimized to the best practical handling size of about 3×5 meter (9.84×16.40 foot) size each, and which can form a combined total surface area of about 600 square meters (6,458.35 square feet) which can be larger than the wing area of a Boeing 747 (554 square meter/5,963 square feet). The blades can be attached to a radial, for example, steel/aluminum structure vertically, and may be tilted at a particular angle of attack at about 5-15 degrees or optimized to about 10 degrees or to the best lifting force output based on the aerodynamic property and shape of the airfoil, angle of attack could be fixed or automatically adjusted within 5-15 degree range, while maintaining a certain clearance between each blade to provide sufficient airflow volume for greater lifting force. The blade shape contour may include a leading edge and a trailing edge forming an airfoil shaped design similar to the cross-section of an aircraft wing, for example, the aircraft conventional early airfoil design which have a thin vertical cross-section and deep camber/curve, that can be modified to have, in addition, deep camber/curve at the horizontal cross-section, representing a spoon curvature shape alike but with straight cut sides, this airfoil shape could detain larger air volume to grant higher lifting force for grater output power from the wind turbine which will affect essentially the total system performance. The blades can be swiveling over a circular rail, e.g., bottom rail and top/head rail by means of wheelers, the wheels units are equipped with braking system, each wheel has its own brake unit located under or above the wheel, based on wheel location, the brakes can be deployed/activated and controlled by the mean of double acting linear actuator that could be electric, pneumatic, or hydraulic. The brakes ‘mainly’ could be triggered in case of emergency stopping and could be used for better control over the rotational speed of the turbine configuration.

Electrical generators may include a set of up to five working, and one stand-by, electrical generators with up to 100 MW capacity for each. The generators may be attached to a main gear by means of a separate gearbox system and controlled automatically for optimum power delivery from the main gear to the generators. In embodiments, the generators room/slab can be reached through an underground passage, passing beneath the air collection area, and extended to a 5-meter (16.40 foot) stairwell diameter at the core of the tower building.

The power bank units are located at the basement or underground area beneath the air collection area and may be fed electrical power by the generators. In embodiments, the units may be distributed in a matrix shape arrangement to minimize electrical cabling requirements and optimize cost. The stored electrical power can thus be used during peak hours or during system shutdowns.

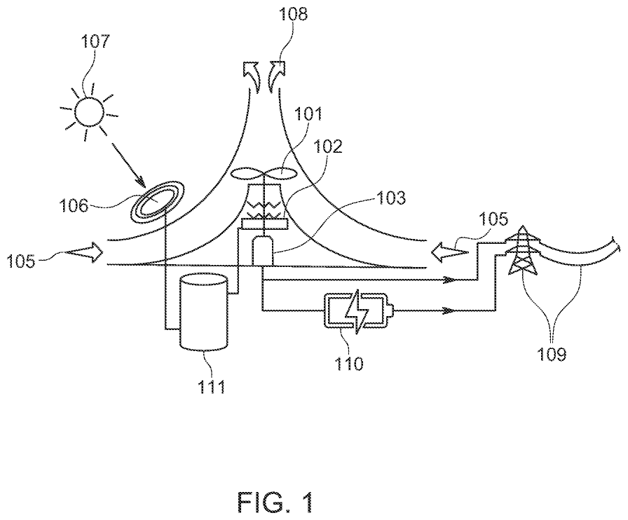

FIG. 1 shows an embodiment of a solar powered wind turbine system of the disclosure. FIG. 1 shows wind turbine 101, solar stove or radiator 102, electrical generator 103, power grid 109, battery (power storage) 110, solar salt tank (thermal storage) 111, airflow inlet/intake 105, solar concentrator 106, the sun 107, and airflow exit/outtake 108.

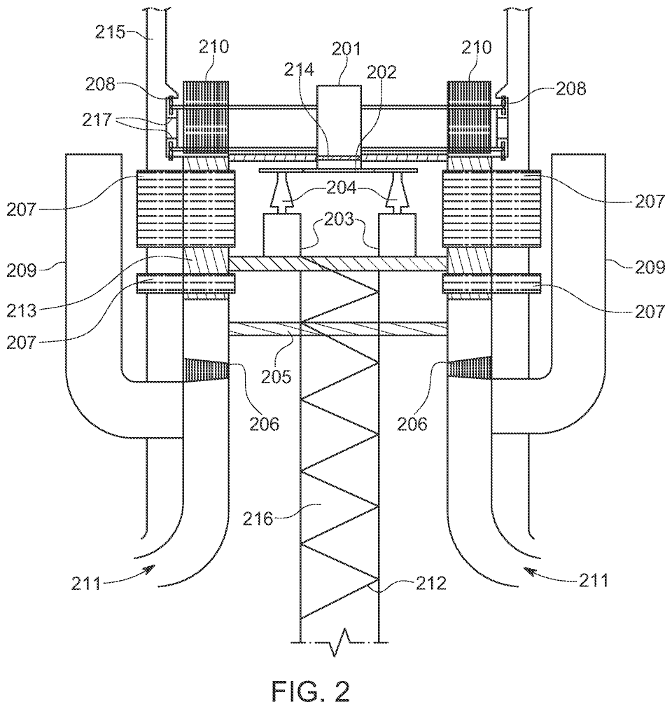

FIG. 2 shows an embodiment of tower of a solar powered wind turbine system of the disclosure. FIG. 2 shows main shaft 201, turbine blades 210, wheels on rail (connected to main shaft and holding the blades) 208, wheel braking system 217 (each wheel has its own brake unit located under or above the wheel, based on wheel location, the brakes can be deployed/activated and controlled by the mean of double acting linear actuator that could be electric, pneumatic, or hydraulic), vents 207, air pressure control vents 209, air flow control shutter/fin 206, vertical air deflectors 213, bearing 214, pillar 215, stairwell 216, main gear 202, generators 203, gear boxes 204, control booth 205, air intake 211, and staircase to control room and generator room 212.

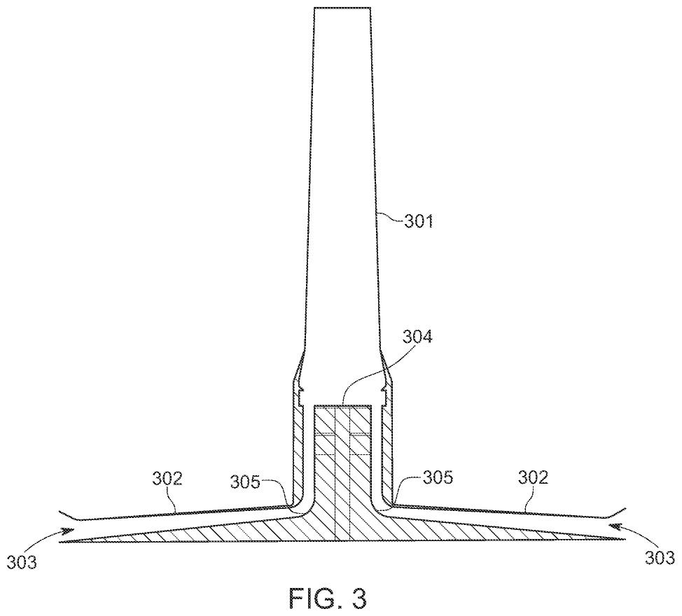

FIG. 3 shows an embodiment of the chimney shielding the tower and airflow of a solar powered wind turbine system of the disclosure. FIG. 3 shows chimney 301 with a tapered shape, air intake 303 with quarter round curvature shape at peripheral opening, tower 304 the tower height from ground level is 30% of the total chimney height from ground level, roof of the air collection area 302, and stove/radiator 305. As shown in FIG. 3 the tapered shape of the chimney may extend gradually over chimney height. The chimney base sectional area opening is 1-10%, or preferably about 5% of the peripheral circumference area opening. The peripheral opening height may be about 5-10% of the chimney height. The total chimney height from ground level to the tip end of the tapered opening may be twice/double the radius of the air basin.

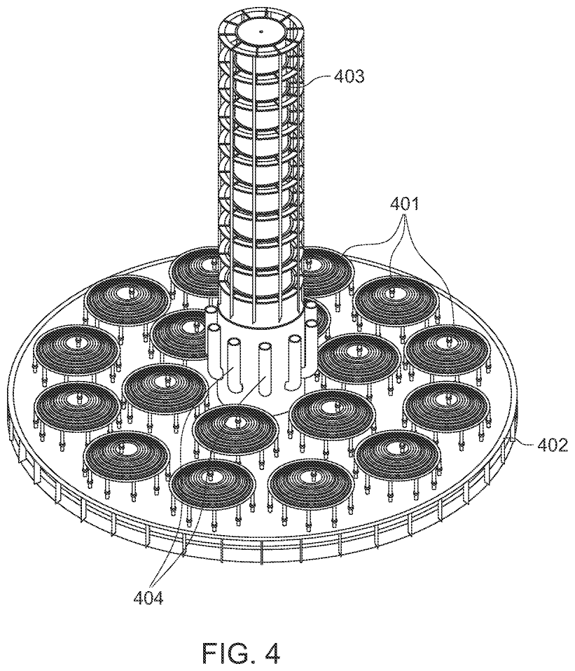

FIG. 4 shows an embodiment of solar concentrator units of the disclosure. FIG. 4 shows solar cell concentrator units 401, rooftop 402, chimney 403, and air pressure control vents 404.

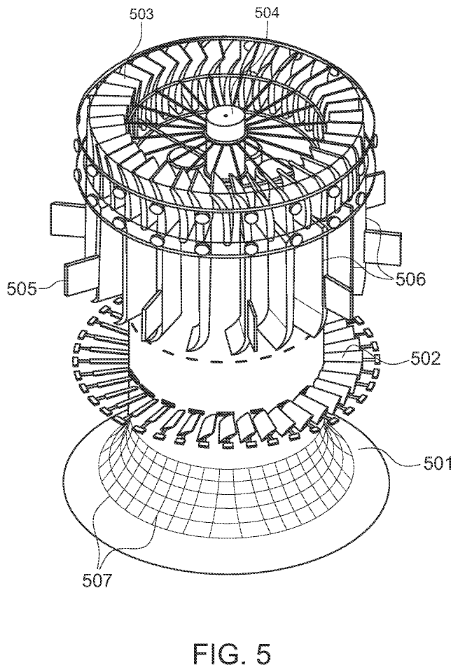

FIG. 5 shows the tower main components of the disclosure. FIG. 5 shows tower base/tower 501, wind turbine blades (air foil) 503, air flow control shutter blades/fins 502, ventilation opening to generators room 505, vertical air deflectors 506, stove (heat radiator) 507, and main shaft 504. In this embodiment, the wind turbine blades operate using the heated air convection updraft flowing up the chimney from the stove/radiator located at the base of the tower.

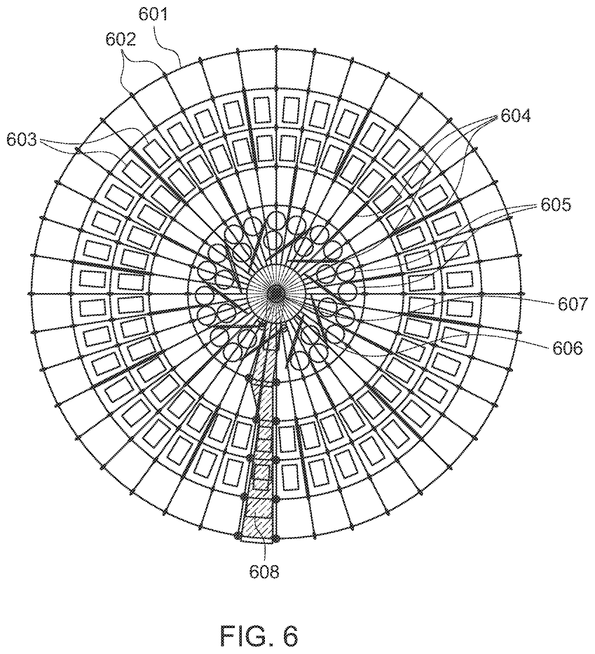

FIG. 6 shows top view of the air collection basin and underground utilities and underground passage to the tower stairwell, FIG. 6 shows air collection basin perimeter 601, reinforced concrete elliptical shape pillars distribution 602, power storage unit distribution 603, horizontal air deflectors shape and distribution 604, thermal storage unit and distribution 605, tower perimeter 606, tower stairwell opening 607, underground passage to the tower stairwell 608.

### Glossary

Convection, as used herein, generally refers to thermal convection, i.e., the movement of air from a high-pressure region to a low-pressure region. This may be accompanied by a corresponding drop or fall of colder, denser, air. See, e.g., convection (heat transfer), Wikipedia, the free encyclopedia, last edited: 17 Jan. 2022, herein incorporated by reference.

The term ‘tower’ as used herein generally refers to a building that is located at the center of the solar powered wind turbine system (air collection area) and shelled by a chimney. Typically, such a structure would be made of a metal (e.g., steel or metal alloy) but could be any other suitable material, e.g., reinforced concrete, stone, and may be insulated.

The term ‘chimney’ as used herein refers to any tube shape type structure, e.g., a thermal chimney, solar chimney, ventilation shaft, ventilation tower, or other similar structure capable of containing and directing a convective airflow updraft created at its bottom. Typically, such a structure would be made of a metal (e.g., aluminum or steel or metal alloy) but could be any other suitable material, e.g., fiberglass, reinforced concrete, stone, and may be insulated.

The term ‘air deflectors’ as used herein refer to any barrier/wall that interfere with an air stream forcing it to change direction, or follow certain direction, and it may be horizontal, e.g., as per the directional walls located and distributed within an air collection area, or, it may be vertical, e.g., as in a set of vertical walls within a tower and located underneath the blades structure. Such a structure would be made of a metal (e.g., aluminum or steel or metal alloy) but could be any other suitable material, e.g., fiberglass, reinforced concrete, gypsum board, and may be insulated.

The term ‘air shutters’ as used herein refer to a set of fin/blade shaped structure that can be used to block or control airflow, such a structure would be made of a metal (e.g., aluminum or steel or metal alloy) but could be any other suitable material, e.g., titanium.

The term ‘control vents’ as used herein refer to the set of air pressure exhaust tubes shaped structure including a pressure sensor to control opening and closing of pressure valves connected to the chimney structure and used to control the amount of air flowing through the chimney. Such a structure would be made of a metal (e.g., aluminum or steel or metal alloy) but could be any other suitable material, e.g., fiberglass, reinforced concrete, and may be insulated.

The term ‘ventilation opening’ as used herein refers air opening intakes. In embodiments, ventilation openings extract air connected to the central tower generators and control room/booth, passing through the chimney structure out to the surrounding natural air. Such a structure would be made of a metal (e.g., aluminum or steel or metal alloy) but could be any other suitable material, e.g., fiberglass, reinforced concrete, and may be insulated.

The term ‘tapered’ generally refers to a gradual reduction of diameter, or width, or cross-sectional area in an elongated object, or more specifically, a tower as described above.

A ‘thermal transfer medium’ generally refers to a liquid, viscous liquid, or the like, including oil and treated oil, water, and salt water, and the like.

A ‘solar power concentrator’ generally refers to a concentrated solar power device or solar concentrator and equipped with sun tracking device. For example, solar concentrator systems can generate solar power by using reflectors, mirrors, or lenses to concentrate an area of sunlight onto a receiver or device to convert the sunlight, for example, into heat. For example, solar concentrator systems as used herein can heat a thermal medium such as water, oil, salt solution, etc., which can be subsequently stored in a thermal storage unit. See e.g., Thermal Energy Storage, Wikipedia, the free encyclopedia, last edited 9 Apr. 2022, herein incorporated by reference.

‘Thermal storage unit’ generally refers to a device or system capable of storing or holding for a period of time, thermal energy. For example, a thermal storage unit may utilize a molten material, for example molten metal, or a molten salt. In preferred embodiments, the thermal storage unit uses a molten salt.

The term ‘airfoil’ as used here in refers to the cross-sectional shape of an object whose motion through a gas is capable of generating significant lift, such as a wing, a sail, or the blades of a propeller, rotor, or turbine. See e.g., Airfoil, Wikipedia, the free encyclopedia, last edited: 21 Mar. 2022, herein incorporated by reference.

A ‘radiator’ as used herein generally refers to a device capable of transferring thermal energy from one medium to another. For example, a radiator of the disclosure may transfer heat from a thermal transfer medium to air. In embodiments, the disclosed radiators may transfer heat through thermal convection. See e.g., Radiator, Wikipedia, the free encyclopedia, last edited: 9 Apr. 2022, herein incorporated by reference.

A ‘wind turbine generator’ as used herein is a device capable converting wind energy into electrical energy. In preferred embodiments, the disclosed wind turbines may include a series of blades that can turn a central shaft to produce electrical power. In embodiments the disclosed turbine generators may include multiple sets of blades which can be turned by natural wind energy or convection up drafts in the disclosed towers. See e.g., Wind Turbine, Wikipedia, the free encyclopedia, last edited: 8 Apr. 2022, herein incorporated by reference.

‘Power storage unit’ as used herein is generally an energy storage device capable of storing electrical energy. In embodiments, batteries, or banks of batteries capable of holding large amounts of electrical energy up to megawatts are preferred. See e.g., Energy Storage, Wikipedia, the free encyclopedia, last edited 15 Mar. 2022, herein incorporated by reference.

Angle of attack for air foils or air blades refers to an angle between the direction of air flow and leading edge of the air foil or blade. See Angle of Attack, Wikipedia, the free encyclopedia, last edited: 6 Apr. 2022, herein incorporated by reference.

While this disclosure includes specific examples, it will be apparent after an understanding of the disclosure of this application has been attained that various changes in form and details may be made in these examples without departing from the spirit and scope of the claims and their equivalents.

1. A solar powered wind turbine system comprising:
an air intake;
a chimney comprising a top outlet and a bottom air intake opening, wherein the chimney is gradually tapered from the bottom air intake opening to the top outlet, and the top outlet has an area that is between about 1 and 10% of the bottom air intake opening area;
the chimney enclosing a tower, the tower comprising between 10 and 50 air deflectors, and a wind turbine comprising blades and disposed at the top outlet of the tower;
a solar power concentrator comprising reflectors, mirrors, or lenses to heat a thermal transfer medium comprising oil;
a thermal storage unit for storing the thermal transfer medium;
a radiator disposed at the base opening of the tower, wherein the thermal transfer medium is transported to the radiator from the thermal storage unit and the radiator heats air from the air intake opening;
wherein the wind turbine blades each comprise an airfoil shape;
an electrical generator connected to the wind turbine; and
a power storage device connected to the electrical generator.

2. The solar powered wind turbine system of claim 1, wherein the wind turbine comprises between about 30 and 50 blades.

3. The solar powered wind turbine system of claim 1, wherein the blades have an angle of attack between about 5 and 15 degrees.

4. (canceled)

5. (canceled)

6. (canceled)

7. The solar powered wind turbine system of claim 1, wherein the thermal storage unit comprises a molten salt.

8. The solar powered wind turbine system of claim 1, wherein the power storage device comprises one or more batteries.

9. (canceled)

10. (canceled)

11. The solar powered wind turbine system of claim 1, wherein the solar power concentrator comprises a sun tracking device.

12. (canceled)

13. (canceled)
